(19) United States
(12) Patent Application Publication
(10) Pub. No.: US 2008/0034243 A1
(43) Pub. Date: Feb. 7, 2008

(54) Method, apparatus and system for exchangeable power sources

(75) Inventor: Randy P. Stanley, Aptos, CA (US)

Correspondence Address: INTEL CORPORATION;c/o INTELLEVATE, LLC, P.O. BOX 52050, MINNEAPOLIS, MN, 55402, US

(73) Assignee: INTEL CORPORATION

(21) Appl. No.: 11/500,570

(22) Filed: Aug. 7, 2006

(51) Int. Cl. G06F 1/00

(52) U.S. Cl. 713/340

(57) ABSTRACT

In some embodiments, a method, apparatus, and system are described for exchangeable power sources. The system may include a body, two or more contacts, and a power adapter. In some embodiments, a power source may be used to provide a supply of power via the two or more contacts. In some embodiments, the power source may be displaced by another power source without significant disruption of electrical connectivity to the system via the two or more contacts. Other embodiments may be described.

### BACKGROUND

1. Technical Field

Some embodiments of the present invention generally relate to exchangeable power sources.

2. Discussion

As portable computing systems become more common, their use requires longer periods of operation. Power sources, including batteries and fuel cells, have limited periods of operation. As such, computing systems need to be powered down or turned off during the exchanging of the power sources. What is needed, therefore, are ways to maintain the supply of power to computing systems, particularly during the exchange of power sources.

### BRIEF DESCRIPTION OF THE DRAWINGS

Various advantages of embodiments of the present invention will become apparent to one of ordinary skill in the art by reading the following specification and appended claims, and by referencing the following drawings, in which:

FIG. 1 is an illustration of an apparatus for the exchange of power sources according to some embodiments of the system;

FIG. 2 is an illustration of body and power source configurations according to some embodiments of the invention;

FIG. 3 is an illustration of exchanging power sources according to some embodiments of the invention;

FIG. 4 is an illustration of various contact configurations according to some embodiments of the invention;

FIG. 5 is a flowchart illustrating methods for exchanging power sources according to some embodiments of the invention; and

FIG. 6 includes a schematic diagram of a computer system according to some embodiments of the invention.

### DETAILED DESCRIPTION OF SOME EMBODIMENTS

Reference is made to some embodiments of the invention, examples of which are illustrated in the accompanying drawings. While the present invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims. Moreover, in the following detailed description of the invention, numerous specific details are set forth in order to provide a thorough understanding of the invention. However, the invention may be practiced without these specific details. In other instances, well-known methods, procedures, components and circuits have not been described in detail as not to unnecessarily obscure aspects of the invention.

Reference in the specification to “one embodiment” or “some embodiments” of the invention means that a particular feature, structure or characteristic described in connection with the embodiment is included in at least some embodiments of the invention. Thus, the appearances of the phrase “in some embodiments” or “according to some embodiments” appearing in various places throughout the specification are not necessarily all referring to the same embodiment.

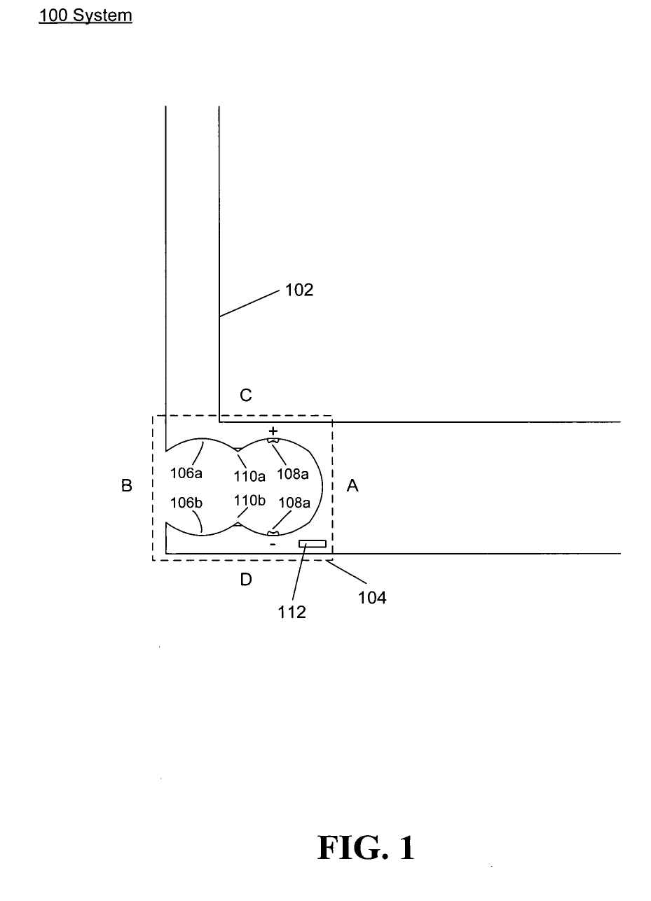

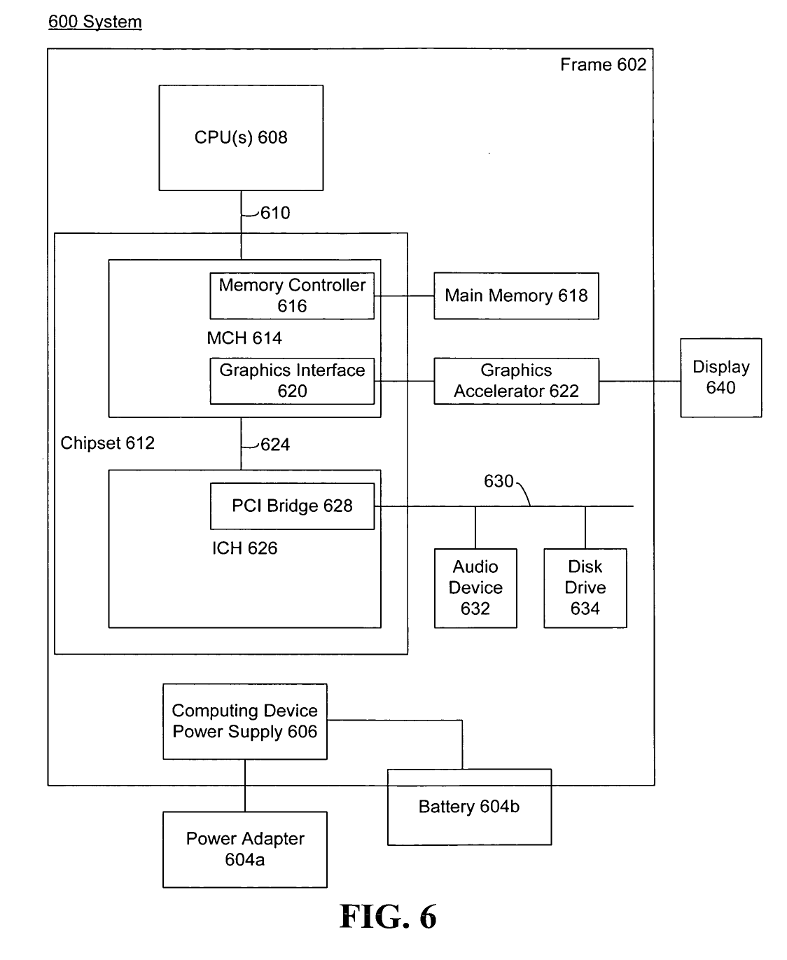

According to some embodiments, the method may be implemented within a computing system, such as, but not limited to, a mobile computer, a desktop computer, a server computer, and/or a handheld computer. The system described with respect to FIG. 6, below, may be used to perform the operations described herein with respect to FIGS. 1-5, as one of ordinary skill in the relevant arts would appreciate based at least on the teachings provided herein.

FIG. 1 is an illustration of an apparatus 104 for the exchange of power sources according to some embodiments of the system. The body 104 may be an apparatus and may be implemented in a system 100, such as, but not limited to, a device or appliance, which may use or rendered capable of using, one or more power sources, such as, but not limited to, a mobile device, cellular telephone, mobile computer, a desktop computer, a server computer, and/or a handheld computer, according to some embodiments of the invention. The system 100 may include a frame 102 within which the body 104 may be situated.

Furthermore, in some embodiments, the body 104 may include a front side (A), a rear side (B), and a pair of lateral sides (C and D). The body may include one or more engaging portions 110a-b. In some embodiments, the engaging portions may include protruding features, such as, but not limited to, rails or rail-like features capable of guiding the power source.

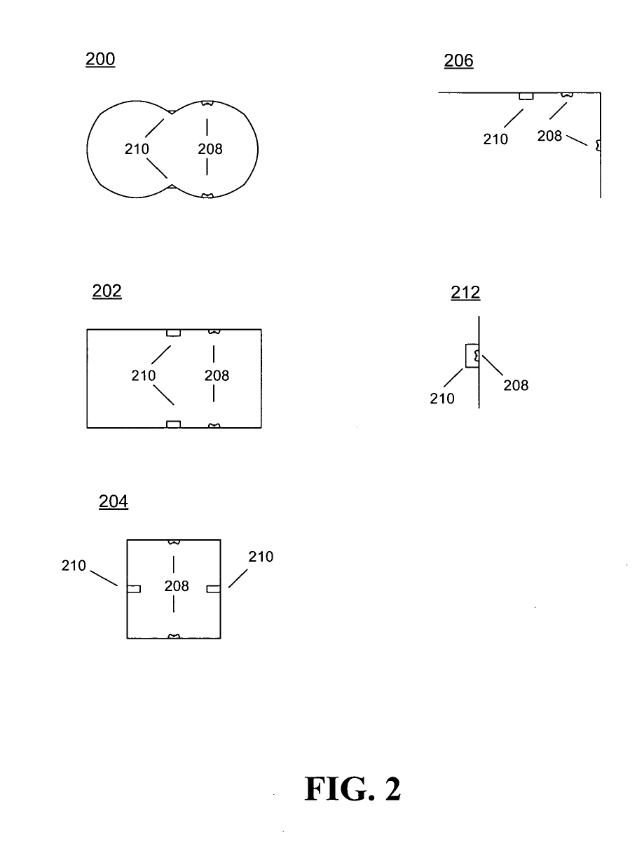

In some embodiments, one or more of the sides may be at least partially open to the outside. As is shown in some embodiments in FIGS. 1 and 2, the configurations may be a range of closed and open, and internal and external. In some embodiments, the rear side (B) is closed within the body 104 or the frame 102, as one of ordinary skill in the relevant art would appreciate based at least on the teachings described herein.

The pair of lateral sides (C and D) may have different shapes, as indicated at 106a-b, and shown in some embodiments in FIG. 2, below. The sides C and D may also include two or more contacts 108a-b positioned on the sides of the body. In some embodiments, the two or more contacts may provide electrical connectivity with one or more power sources (not shown). In some embodiments, the contacts 108 may be aligned with contacts on the one or more power sources. In some embodiments, a contact may be thought of as either a positive or negative terminal, as one of ordinary skill in the relevant art would appreciate based at least on the teachings described herein. In some embodiments, the contacts 108 may include one or more sense resistors to enable determining the presence, identity, and/or displacement of one or more power sources.

In some embodiments, the one or more power sources may include a battery, such as, but not limited to a nickel-cadmium battery or a lithium-ion battery. In some embodiments, the one or more power sources may be a fuel cell or a hybrid fuel cell and battery, as one of ordinary skill in the relevant art would appreciate based at least on the teachings described herein. Additional embodiments involving power sources are described with respect to FIG. 6.

In some embodiments, a power adapter 112 may be coupled to the body 104 and may convert alternating current (AC) from an external source (not shown) to direct current (DC) within the body 104. In some embodiments, the power adapter 112 may not be included as a separate feature of the body 104, and may be provided in the shape of a power source to be inserted into the body 104, as one of ordinary skill would appreciate based at least on the teachings provided herein. Furthermore, in some embodiments, the body 104 may include logic (not shown) to couple the body 104 to the system 100, such that electrical connectivity may be established and/or maintain between the body 104 and the system 100; and information may be exchanged between the body 104 and the system 100. In some embodiments, the logic may include hardware, software, and/or firmware, as one of ordinary skill will appreciated, based at least on the teachings provided herein.

FIG. 2 is an illustration of body and power source configurations according to some embodiments of the invention, where some embodiments of the engaging portions and contacts are shown. In some embodiments, the body 200 may have sides (A-D) generally, but not specifically, shaped as shown to support one or more engaging portions 210 that may be used restrain the movement of the one or more power sources in or on the body 200. In some embodiments, the displacement direction of the one or more power sources in the body 200 may be substantially one direction.

Furthermore, two or more contacts 208 may be included in the body 200, according to some embodiments. In some embodiments, the two or more contacts 208 may be separated by a distance greater than the size of the contact, as generally shown in body 200. In some embodiments, the two or more contacts 208 may be configured very close or within one another or very close or within the engaging portion 208, as generally shown in body 212.

In some embodiments, the shape of the body may resemble that of i) a rectangle, as shown in body 202; or ii) a square, as shown in body 204. In some embodiments, the bodies 202 and/or 204 may include one or more engaging portions 210 and/or contacts 208, as shown. As one of ordinary skill in the relevant art would appreciate, based at least on the teachings provided herein, any of the bodies 200, 202, 204, 206, or 212, variations or their equivalents, may be implemented in the embodiments of the invention.

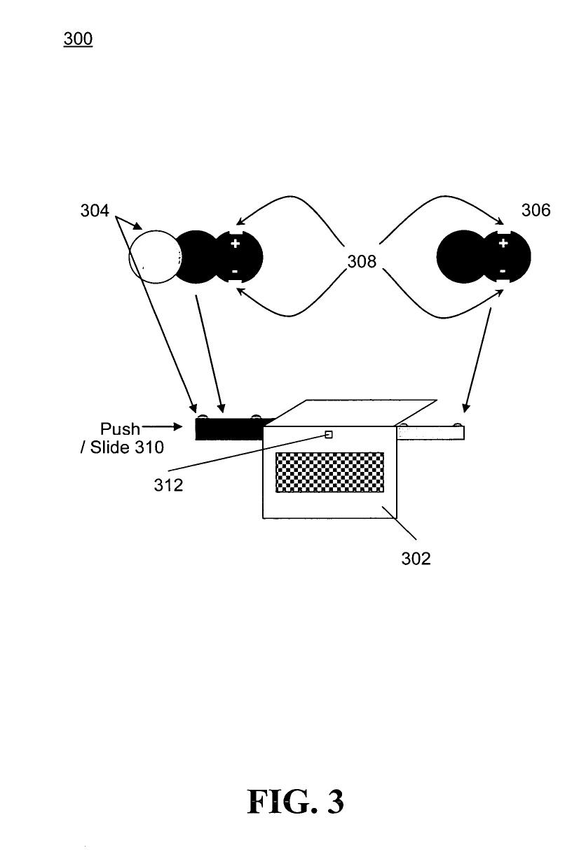

FIG. 3 is an illustration of exchanging power sources according to some embodiments of the invention. According to some embodiments of the invention, the one or more power sources may displace one another without significant disruption of the electrical connectivity between at least one of the power sources and the body 104. In FIG. 3, a system 300 is shown, where a second power source 304 may displace at 310 a first power source 306.

As shown, each of the power sources may include a number of contacts 308. During displacement, the first power source 306 moves out of the body, such as, but not limited to, bodies 104, 200, 202, or 204, according to some embodiments of the invention; and is replaced by the second power source 304. In some embodiments, the system 300 may not experience significant disruption of electrical connectivity between at least one of the power sources, 304 or 306. In some embodiments, the displacement of the first power source 306 by the second power source 304 occurs substantially by sliding the second power source 304 into the body along the one or more engaging portions or along the pair of lateral sides (C and D) to displace the first power source 306.

In some embodiments, an interlocking mechanism at the engaging portions 110 may be implemented to restrain movement of the one or more power sources in the body or apparatus. In some embodiments, the interlocking mechanism prevents the one or more power sources from being moved or removed in a direction that would result in a disruption of electrical connectivity. In some embodiments, the interlocking mechanism may prevent the displacement of one power source without the replacement of that power source with another power source. As one of ordinary skill would appreciate based at least on the teachings provided herein, the interlocking mechanism may be one or more ratchets, one or more spring or tension enabled pins or blocks to restrain movement. In some embodiments, the interlocking mechanism may be disabled.

In some embodiments, the removal of one or more power sources may be dependent upon the insertion of a subsequent power source to a point where the interlocking mechanism restrains the movement of the subsequent power source until at least the replacement and/or displacement is complete.

In some embodiments, the system 300 may register the displacement/replacement of one power source for another, as is described elsewhere herein. In some embodiments, the system 300 may perform some preventative measures, or no preventative measures, such as, but not limited to, reducing power consumption, such as, but not limited to, dimming a display of the system, saving data from memory to a storage device, etc. Furthermore, a lock mechanism 312 may be present to hold at least one of the one or more power sources substantially in place within the body or system 300.

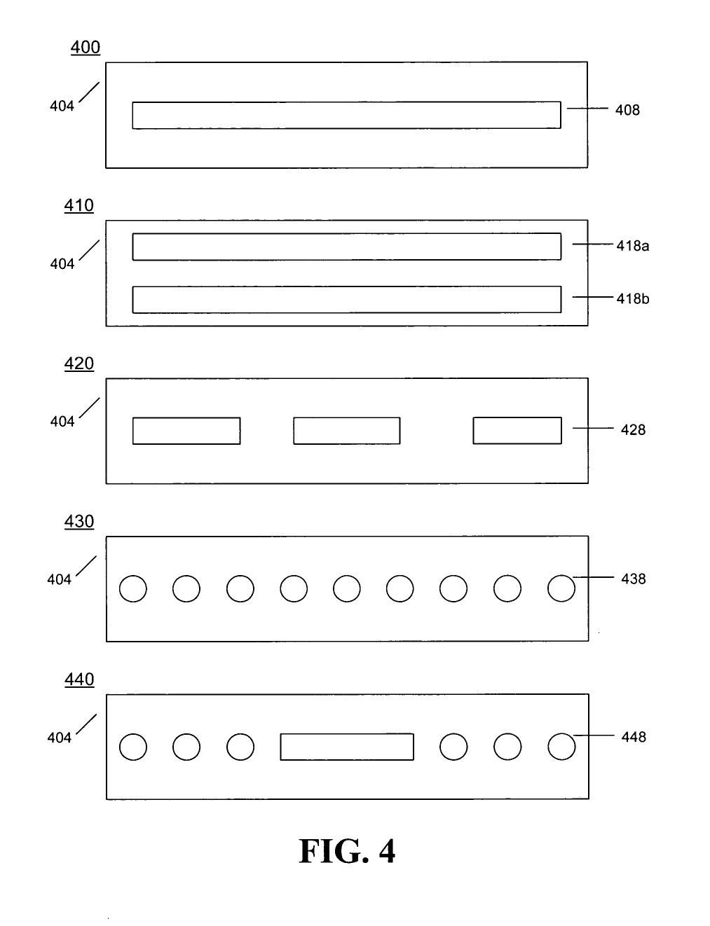

FIG. 4 is an illustration of various contact configurations according to some embodiments of the invention. In FIG. 4, configurations 400, 410, 420, 430, and 440 are shown, as some embodiments of the invention. As one of ordinary skill in the relevant art would appreciate, based at least on the teachings provided herein, the embodiments of the invention are not limited to these configurations. Indeed, one of ordinary skill in the relevant art would appreciate alternative contact configurations based upon or equivalent to these configurations.

As such, configuration 400 shows a surface, side, or region of a power source 404 with a configuration 408 of two or more contacts. In some embodiments, the configuration 408 may be referred to as a single strip arrangement. Moreover, configuration 410 shows a surface, side, or region of a power source 404 with a pair of substantially parallel strips 418a and 418b, wherein each strip may include one, two, or more contacts. In some embodiments, a configuration 420 may include a series of similar contact points of rectilinear (yielding near rectangles) (428) or curvilinear (yielding near circles) shape (438), as well as a series of dissimilar contact points of various shapes that may include both rectilinear and circular shapes (448). Other embodiments, not shown, may include various other shapes, as one of ordinary skill in the relevant art would appreciate based at least on the teachings provided herein.

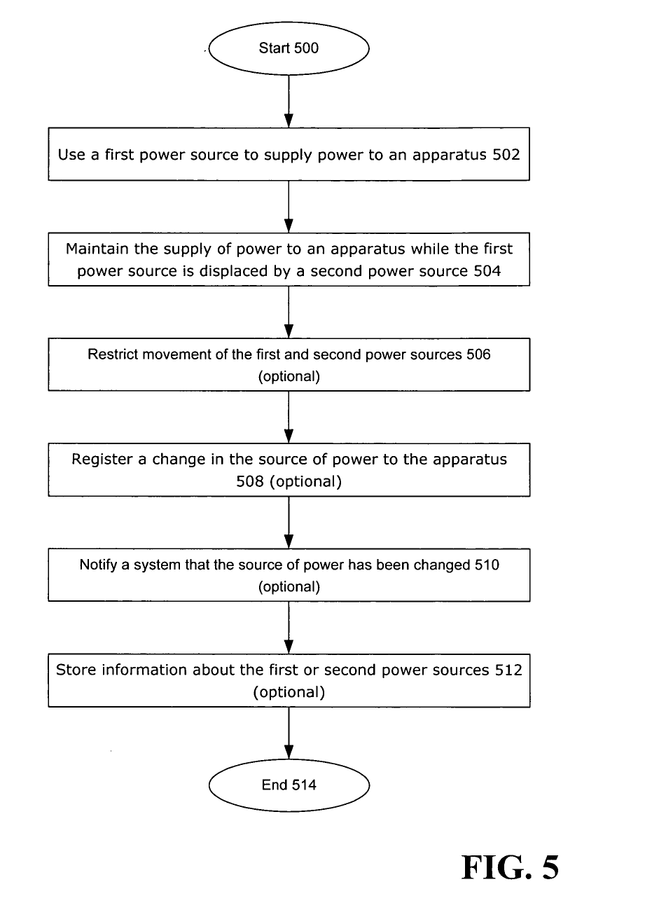

FIG. 5 is a flowchart illustrating methods for exchanging power sources according to some embodiments of the invention. In FIG. 5, a process begins at start 500 and proceeds to 502, where it may use a first power source to supply power to an apparatus. In some embodiments, the apparatus may include a body, such as, but not limited to, body 104, 200, 202, 204, 206, and/or 212. According to some embodiments of the invention, the power source may be a battery, fuel cell, a hybrid of the both, or an equivalent source of power. The process may then proceed to 504.

At 504, the process may substantially maintain or at least prevent a significant disruption of electrical connectivity to the apparatus while the first power source is displaced by a second power source. In some embodiments, as described in detail elsewhere herein, the displacement may occur within the apparatus or body, such as, but not limited to body 104, 200, 202, 204, 206, and/or 212. The process may then optionally proceed to 506. In some embodiments, the operation of optional processes may not depend on any order or prior operation. Therefore, the optional process at 506 may not need to have occurred for the process of FIG. 5 to proceed to 508 and likewise for any of the other operations, especially the optional operations.

At 506, the process may restrict movement of the first power source or the second power source. In some embodiments, a locking mechanism may be used to hold either power source in place. In some embodiments, an engaging portion, either with or without an interlocking mechanism, may be used to guide the movements of power sources within the body. Embodiments of locking and interlocking mechanisms are described in detail elsewhere herein, with respect to FIGS. 2 and 3. The process may then optionally proceed to 508.

At 508, the process may register a change in the source of power to the apparatus or body. In some embodiments, the body may sense the change in power source and register that change within the body. In some embodiments, as one of ordinary skill would appreciate based at least on the teachings provided herein, the body may be able to determine the identity of a specific power source by at least an identifier obtained from the power source. The process may optionally proceed to 510.

At 510, the process may notify a system that the source of power has been changed. In some embodiments, the system includes a device or appliance, such as, but not limited to, a mobile device, a cellular telephone, a mobile computer, a desktop computer, a server computer, or a handheld computer. In some embodiments, the system may include a frame within which the body or apparatus may reside. The process may optionally proceed to 512.

At 512, the process may store information about the first or second power source. In some embodiments, the information may be stored in a main memory, a disk drive, a cache, or a chipset memory, as are described with respect to FIG. 6, below. In some embodiments, the information may include the identity of the one or more power sources used by the body or apparatus, the duration of use, power levels, and displacement information, as one of ordinary skill would appreciated based at least on the teachings provided herein. The process may then proceed to 514, where the proceed ends and is able to perform any of the previous operations again.

FIG. 6 includes a schematic diagram of a computer system according to some embodiments of the invention. The computer system 600 includes a frame (or computing device) 602 and a power adapter 604 (e.g., to supply electrical power to the computing device 602). The computing device 602 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 602 (e.g., through a computing device power supply 606) from one or more of the power sources, such as the power sources described above with respect to FIGS. 1-5. As such, in some embodiments, the power sources may include one or more battery packs, an alternating current (AC) outlet (e.g., through a transformer and/or adaptor such as a power adapter 604), automotive power supplies, airplane power supplies, and the like. In some embodiments, the power adapter 604 may transform the power supply source output (e.g., the AC outlet voltage of about 110 VAC to 240 VAC) to a direct current (DC) voltage ranging between about 7 VDC to 12.6 VDC. Accordingly, the power adapter 604 may be an AC/DC adapter.

The computing device 602 may also include one or more central processing unit(s) (CPUs) 608 coupled to a bus 610. In some embodiments, the CPU 608 may be one or more processors in the Pentium® family of processors including the Pentium® II processor family, Pentium® III processors, Pentium® IV processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multiple core design.

A chipset 612 may be coupled to the bus 610. The chipset 612 may include a memory control hub (MCH) 614. The MCH 614 may include a memory controller 616 that is coupled to a main system memory 618. The main system memory 618 stores data and sequences of instructions that are executed by the CPU 608, or any other device included in the system 600. In some embodiments, the main system memory 618 includes random access memory (RAM); however, the main system memory 618 may be implemented using other memory types such as dynamic RAM (DRAM), synchronous DRAM (SDRAM), and the like. Additional devices may also be coupled to the bus 610, such as multiple CPUs and/or multiple system memories.

The MCH 614 may also include a graphics interface 620 coupled to a graphics accelerator 622. In some embodiments, the graphics interface 620 is coupled to the graphics accelerator 622 via an accelerated graphics port (AGP). In an embodiment, a display (such as a flat panel display) 640 may be coupled to the graphics interface 620 through, for example, a signal converter that translates a digital representation of an image stored in a storage device such as video memory or system memory into display signals that are interpreted and displayed by the display. The display 640 signals produced by the display device may pass through various control devices before being interpreted by and subsequently displayed on the display.

A hub interface 624 couples the MCH 614 to an input/output control hub (ICH) 626. The ICH 626 provides an interface to input/output (I/O) devices coupled to the computer system 600. The ICH 626 may be coupled to a peripheral component interconnect (PCI) bus. Hence, the ICH 626 includes a PCI bridge 628 that provides an interface to a PCI bus 630. The PCI Bridge 628 provides a data path between the CPU 608 and peripheral devices. Additionally, other types of I/O interconnect topologies may be utilized such as the PCI Express™ architecture, available through Intel® Corporation of Santa Clara, Calif.

The PCI bus 630 may be coupled to an audio device 632 and one or more disk drive(s) 634. Other devices may be coupled to the PCI bus 630. In addition, the CPU 608 and the MCH 614 may be combined to form a single chip. Furthermore, the graphics accelerator 622 may be included within the MCH 614 in other embodiments. As yet another alternative, the MCH 614 and ICH 626 may be integrated into a single component, along with a graphics interface 620.

Additionally, other peripherals coupled to the ICH 626 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 602 may include volatile and/or nonvolatile memory.

As may be evident from the system 600 and the embodiments described with respect to FIGS. 1-5, some embodiments of the invention may be implemented in the system 600.

In some embodiments, the frame or computing device 602 may include more than one body or apparatus, as one of ordinary skill in the relevant art would appreciate based at least on the teachings described herein.

Embodiments of the invention may be described in sufficient detail to enable those skilled in the art to practice the invention. Other embodiments may be utilized, and structural, logical, and intellectual changes may be made without departing from the scope of the present invention. Moreover, it is to be understood that various embodiments of the invention, although different, are not necessarily mutually exclusive. For example, a particular feature, structure, or characteristic described in some embodiments may be included within other embodiments. Those skilled in the art can appreciate from the foregoing description that the techniques of the embodiments of the invention can be implemented in a variety of forms.

Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. An apparatus comprising:
a body including one or more engaging portions; and
two or more contacts positioned on the body, the two or more contacts to provide electrical connectivity with one or more power sources,
wherein the one or more power sources displace one another without significant disruption of the electrical connectivity between at least one of the power sources and the apparatus.

2. The apparatus of claim 1, wherein the body is at least partially open.

3. The apparatus of claim 1, further comprising:
logic to couple the apparatus to a system.

4. The apparatus of claim 3, wherein the system includes a device or appliance, wherein the device includes a mobile device, cellular telephone, mobile computer, a desktop computer, a server computer, or a handheld computer.

5. The apparatus of claim 1, wherein the two or more contacts are configured in one or more arrangements within the apparatus.

6. The apparatus of claim 5, wherein the one or more arrangements includes a single strip, a pair of substantially parallel strips, a series of similar contact points, or a series of dissimilar contact points.

7. The apparatus of claim 1, further comprising:
a lock mechanism to hold at least one of the one or more power sources substantially in place within the apparatus.

8. The apparatus of claim 1, further comprising:
an interlocking mechanism to restrain movement of the one or more power sources in the apparatus such that the electrical connectivity is not substantially disrupted during displacement.

9. The apparatus of claim 8, wherein removal of the one or more power sources is dependent on insertion of a subsequent power source to a point where the interlocking mechanism restrains the movement of the subsequent power source until at least electrical connectivity with the subsequent power source is substantially established.

10. The apparatus of claim 1, wherein the displacement of a first power source by a second power source occurs substantially by sliding the second power source into the apparatus along the one or more engaging portions to displace the first power source.

11. A system comprising:
a frame;
a body including one or more engaging portions; and
two or more contacts positioned on the body, the two or more contacts to provide electrical connectivity with one or more power sources,
wherein the one or more power sources displace one another without significant disruption of the electrical connectivity between at least one of the power sources and the body.

12. The system of claim 11, further comprising:
a power adapter to convert alternating current from an external source to direct current within the body.

13. The system of claim 11, wherein the body is at least partially open.

14. The system of claim 11, further comprising:
logic to couple the body to a system.

15. The system of claim 14, wherein the system includes a device or appliance, wherein the device includes a mobile device, cellular telephone, mobile computer, a desktop computer, a server computer, or a handheld computer.

16. The system of claim 11, wherein the two or more contacts are configured in one or more arrangements within the body.

17. The system of claim 16, wherein the one or more arrangements includes a single strip, a pair of substantially parallel strips, a series of similar contact points, or a series of dissimilar contact points.

18. The system of claim 11, further comprising:
a lock mechanism to hold at least one of the one or more power sources substantially in place within the body.

19. The system of claim 11, further comprising:
an interlocking mechanism to restrain movement of the one or more power sources in the apparatus such that the electrical connectivity is not substantially disrupted during displacement.

20. The system of claim 19, wherein removal of the one or more power sources is dependent on insertion of a subsequent power source to a point where the interlocking mechanism restrains the movement of the subsequent power source until at least electrical connectivity with the subsequent power source is substantially established.

21. The system of claim 11, wherein the displacement of a first power source by a second power source occurs substantially by sliding the second power source into the body along the one or more engaging portions to displace the first power source.

22. A method comprising:
using a first power source to supply power to an apparatus; and
maintaining the supply of power to the apparatus while the first power source is displaced by a second power source.

23. The method of claim 22, further comprising:
restricting movement of the first power source or the second power source.

24. The method of claim 22, further comprising:
registering a change in the source of power to the apparatus.

25. The method of claim 24, further comprising:
notifying a system that the source of power has been changed.

26. The method of claim 25, wherein the system includes a mobile computer, a desktop computer, a server computer, or a handheld computer.

27. The method of claim 22, further comprising:
storing information about the first or second power source.

28. The method of claim 27, wherein the information is stored in a main memory, a disk drive, a cache, or a chipset memory.
